(19) United States
(12) Patent Application Publication
(10) Pub. No.: US 2008/0084859 A1
(43) Pub. Date: Apr. 10, 2008

(54) System and method for maintaining a network connection in a wireless network

(76) Inventor: Brian Scott Sullivan, Watauga, TX (US)

Correspondence Address: LAW OFFICES OF JAMES E. WALTON, PLLC, 1169 N. BURLESON BLVD., SUITE 107-328, BURLESON, TX, 76028, US

(21) Appl. No.: 11/545,742

(22) Filed: Oct. 10, 2006

(51) Int. Cl. H04B 7/216

(52) U.S. Cl. 370/342

(57) ABSTRACT

The disclosed method and apparatus provides for improved handoffs for wireless-networking devices when roaming in a wireless network. An exemplary embodiment includes a session initiation protocol (SIP) device that includes a SIP enabled application for securing a plurality of registered internet protocol (IP) connections to respective wireless access points. The device also includes a network interface for issuing a SIP message for notifying a SIP server to handoff the connection from a first access point to a second access point with which the device already has a registered connection. The SIP message can include an IP address previously assigned to the device by the second access point.

### TECHNICAL FIELD

This invention relates to wireless network communications, methods, and devices. More specifically, this invention relates to methods and apparatus for improved handoff capabilities that allow for improved network connectivity in a roaming environment.

### BACKGROUND

Computer networks that include wireless networking have become increasingly popular over recent years. Advances in wireless networking technology have allowed for data transfer rates that are comparable with wired connections. Also, reduction in prices for wireless networking components, such as wireless routers and wireless networking cards, have made the cost of setting up a wireless computer network competitive in comparison with retrofitting an existing home or office with network wiring. Users also enjoy the increased mobility afforded by a wireless network where their computers do not need to be tethered to a wall outlet.

Increased availability of wireless networks has led to a new generation of computing devices that rely primarily on a wireless network. For example, there are now commercially-available telephones that access Voice-over-IP (VoIP) or Public Switched Telephone Network (PSTN) connections via a wireless or Wi-Fi network. One example of such devices is Session Initiation Protocol (SIP) phones. However, existing wireless networks and networking components were not designed for the kind of constant streaming data of a SIP phone. One significant shortcoming is the ability to allow a SIP phone to seamlessly change, or “handoff,” the Access Point (AP) it is using for network access. Current handoff processes involve several steps, which can result in dropped calls or noticeable periods of silence during a telephone call.

### SUMMARY

According to one aspect of the present invention, a session initiation protocol (SIP) device is provided that includes a SIP enabled application for securing a plurality of registered internet protocol (IP) connections to respective wireless access points. The device also includes a network interface for issuing one or more SIP messages for transferring a data stream from one of the registered IP connections to another, thereby changing which of the registered IP connections is an active connection. The SIP messages can include an IP address assigned to the device by an access point associated with a strongest available connection. For example, in some embodiments the SIP messages can include a RE-INVITE message.

The SIP enabled device can also include a memory for storing information about the plurality of registered connections. The information in the memory can include a plurality of IP addresses assigned to the device by respective access points. The information in the memory can also include information about a strength of the signals received from each of the access points.

In some embodiments, the SIP device can be a SIP phone. The device can also include a display for showing a connection status of each of the plurality of registered IP connections.

According to another aspect of the present invention, a method of controlling a session initiation protocol (SIP) device includes securing a plurality of registered internet protocol (IP) connections to respective wireless access points. The method also includes issuing one or more SIP messages for transferring a data stream from one of the registered IP connections to another, thereby changing which of the registered IP connections is an active connection. In some embodiments, the SIP messages can include an IP address assigned to the device by an access point associated with a strongest available connection. For example, in some embodiments the SIP messages can include a RE-INVITE message.

The method can also include storing information about the plurality of registered connections. In some embodiments, the information can include a plurality of IP addresses assigned to the device by respective access points. In some embodiments, the information can also include storing information about a strength of the signals received from each of the access points.

In some embodiments, the method can be performed by a SIP device operable as a SIP phone. In some embodiments, the method can include displaying a connection status of each of the plurality of registered IP connections.

According to another aspect of the present invention, a handoff method for a session initiation protocol (SIP) device for transferring an active connection from a first access point to a second access point includes selecting an access point to serve as the second access point from among a plurality of access points with which the device has a registered connection by determining which of the plurality of access points is providing a strongest signal. The method also includes sending a first SIP message via the first access point, wherein the SIP message includes an IP address assigned to the device by the selected second access point. The method further includes receiving a second SIP message via the selected second access point that was issued in response to the first SIP message. Finally, the method includes sending a third SIP message in response to the second SIP message indicating that data will be accepted from the selected second access point.

In some embodiments, the first SIP message can be a RE-INVITE message. In some embodiments, the second SIP message can be an INVITE message. In some embodiments, the third SIP message can be an OK message.

### BRIEF DESCRIPTION OF THE DRAWINGS

Embodiments are illustrated by way of example in the accompanying figures, in which like reference numbers indicate similar parts, and in which:

FIG. 1 shows an illustration of a roaming environment for a wireless communications device;

FIG. 2 shows a diagram of a SIP enabled device in a roaming environment;

FIG. 3 shows a SIP enabled telephone;

FIGS. 4A and 4B show alternative displays for the SIP enabled telephone shown in FIG. 3;

FIG. 5 shows a flowchart for a handoff process; and

FIG. 6 shows an example of signal flow during initiation and handoff processes.

### DETAILED DESCRIPTION

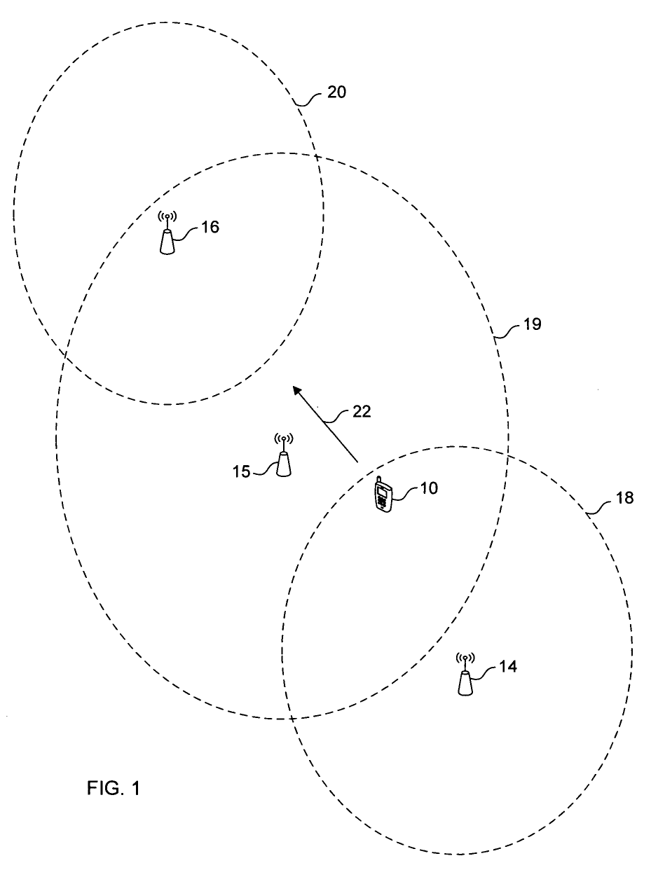

FIG. 1 shows a diagram illustrating a roaming environment for a wireless communications device in a wireless communications network such as Wi-Fi wireless local area networks (WLAN) based on the IEEE 802.11 specifications. In the example shown, a SIP phone 10 is shown as an example of a wireless communications device; however, the discussion is equally relevant to other wireless communications devices, such as those capable of communicating using a Wi-Fi network. Other examples of Wi-Fi devices can include computers and personal digital assistants (PDA).

The Wi-Fi network shown in FIG. 1 includes a plurality of wireless access points (APs) 14-16, which can be any devices that transmit and receive wireless computer communications. For example, the APs 14-16 can include one or more wireless routers, wireless bridges, and/or range extenders. The APs 14-16 can be associated with one or more different networks. Each of the APs 14-16 has a limited range over which it can effectively wirelessly communicate with other wireless communications devices. In FIG. 1, the range of AP 14 is illustrated by broken line 18, the range of AP 15 is illustrated by broken line 19, and the range of AP 16 is illustrated by broken line 20.

In general, the quality of the wireless connection between a client, such as phone 10, and an access point, such as APs 14-16, is a function of the distance between the two. Other factors can also influence the quality of the connection, for example the presence of interposing structures. However, for purposes of the present discussion, and for the sake of simplicity, only the influence of the distance will be addressed.

In FIG. 1, the phone 10 is within effective operating range of the APs 14 and 15, while the AP 16 is out of range. As the phone 10 is moved in the direction indicated by arrow 18, the distance between the phone 10 and the AP 14 increases, while the distance between the phone 10 and the AP 15 decreases. The phone 10, in the position illustrated, is capable of effective wireless communication with the AP 14, for example the beacon signal of the AP 14 is still received at the phone 10 at a level that is above a given threshold or a given signal strength. However, the quality of the wireless connection between the phone 10 and the AP 14 is not as good as a wireless connection between the phone 10 and the AP 15 would be since the AP 15 is much closer to the phone 10. If the phone 10 continues to move in the direction indicated by arrow 22, the signal strength and signal to noise ratio of the signal from the AP 14 will continue to decrease.

Thus, with the phone 10 in communication with a network, for example a LAN or the Internet, via AP 14 and moving in the direction indicated by the arrow 22, it is desirable to transfer, or “handoff,” the wireless connection from AP 14 to AP 15. Otherwise, the AP 14 will eventually be out of range for the phone 10, resulting in a loss of communications between the network and the phone 10.

The handoff process can involve a number of steps. The handoff can be initiated when a client device, such as the phone 10, detects that the quality of its present wireless connection is deteriorating. The client device initiates the handoff by issuing one or more disassociation messages to its current AP. Next, the client device transmits one or more probe requests in order to determine whether there are any APs within range that can be used for wireless communications. If the client device receives probe responses from one or more APs, the client device will select an AP to use for wireless communications. For example, if this handoff process is used in the scenario illustrated in FIG. 1, the phone 10 should receive probe responses from APs 14 and 15. Since the signal strength of the AP 15 is better than that of the AP 14 due to its closer proximity, the phone 10 selects the AP 15 for wireless communications. Once an AP is selected, the client device begins an association process with the selected AP. The association process includes an exchange of several authentication and association messages between the client device and the selected AP. Finally, once the association process is complete, the client device can continue communications with the network.

The problem with this handoff approach is that it requires a break in communications between the client device and the network while the client device re-associates with another AP. The break in communications is more noticeable for some applications than for others; for example, during an IP telephone call, the communications break during handoff can be a noticeable interruption in the audio stream, sometimes resulting in degraded call quality, echoes, and/or the call being dropped altogether.

An improved handoff process can include securing multiple Wi-Fi connections with full network connectivity simultaneously working at layer 3 and layer 7 networking. A device adapted to perform the improved handoff process can register to servers on multiple available network connections. The improved handoff process allows a Wi-Fi device to stay connected as the device moves relative to multiple APs. The Wi-Fi device can automatically keep track of the strength of the signal from the device to multiple APs. As the device moves, the AP receiving the strongest signal changes, and the Wi-Fi device hands off the connection from one AP to another via the simultaneous multiple Wi-Fi connections.

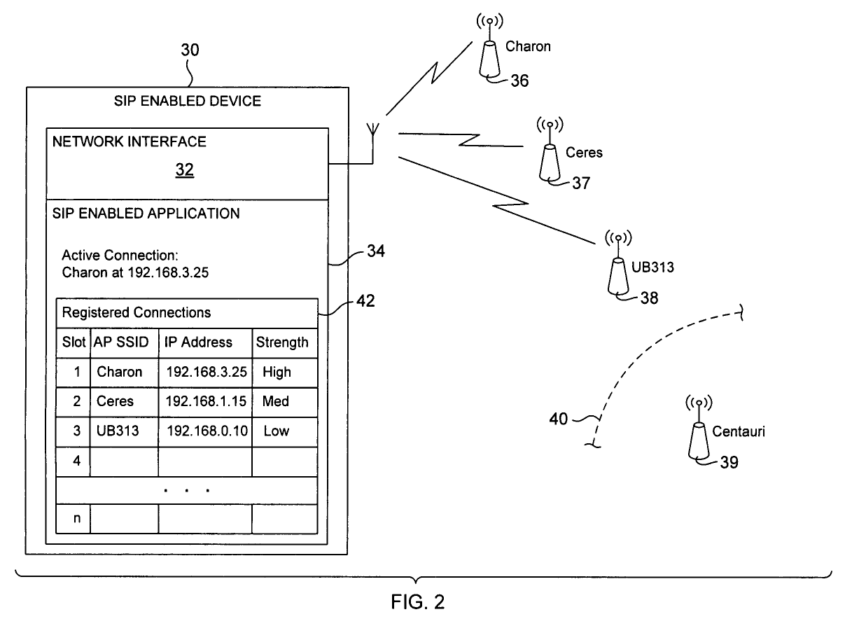

FIG. 2 shows, as an example of a device adapted to perform the improved handoff process, a SIP enabled device 30. The device 30 includes a network interface 32 and a SIP enabled application 34. The network interface 32 can include functionality for interfacing to a network through one or more of a variety of wired and/or wireless connections (e.g. 802.11, T1, T3, 56 kb, X.25). The SIP enabled application 34 can be comprised of a combination of software and hardware components. For example, the SIP enabled application 34 can include software stored in electronic memory and a processor for performing steps according to instructions in the software code.

In FIG. 2, the device 30 is in a roaming environment that includes four APs 36-39. Each of the APs 36-39 has a respective service set identifier (SSID): the SSID for AP 36 is Charon, the SSID for AP 37 is Ceres, the SSID for AP 38 is UB313, and the SSID for AP 39 is Centauri. The device 30 is only within effective operating range of APs 36-38. The effective operating range of AP 39 has a boundary shown by the broken line 40. Thus, the device 30 is not within effective operating range of the AP 39.

After a Wi-Fi site-survey of the roaming environment, the SIP enabled application 34 has established registered connections with APs 36-38. The registration process can include requesting and acquiring an IP address, registering with the associated SIP server (not shown), and any other steps necessary for being ready for IP traffic. The device 30 uses one of the multiple connections as the “active” connection (i.e., the primary connection being used for exchange of data). The application 34 stores information about each of the registered connections in an electronic memory.

In some embodiments, the information can be stored as a registered connections table 42. As shown in FIG. 2, the table 42 can include the SSID of the associated AP, the IP address that the associated AP has assigned to the device 30, and the signal strength of the respective connection. While the signal strengths are shown in FIG. 2 as simply “High,” “Med,” and “Low,” alternative metrics can be used. For example, the table 42 can use a numeric range, such as a Received Signal Strength Indication (RSSI). For example, the value stored for signal strength can range from 0 to 255, or from 0 to 100, where a higher number means better signal strength. Note that the device 30 preferably uses the connection with the strongest signal for data transfer.

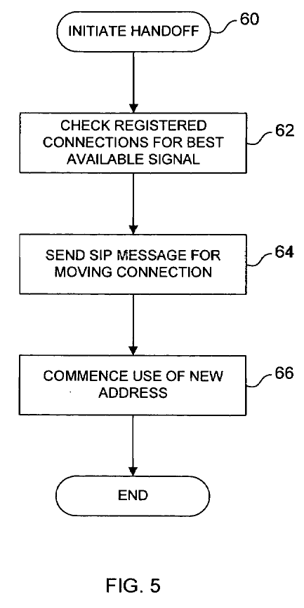

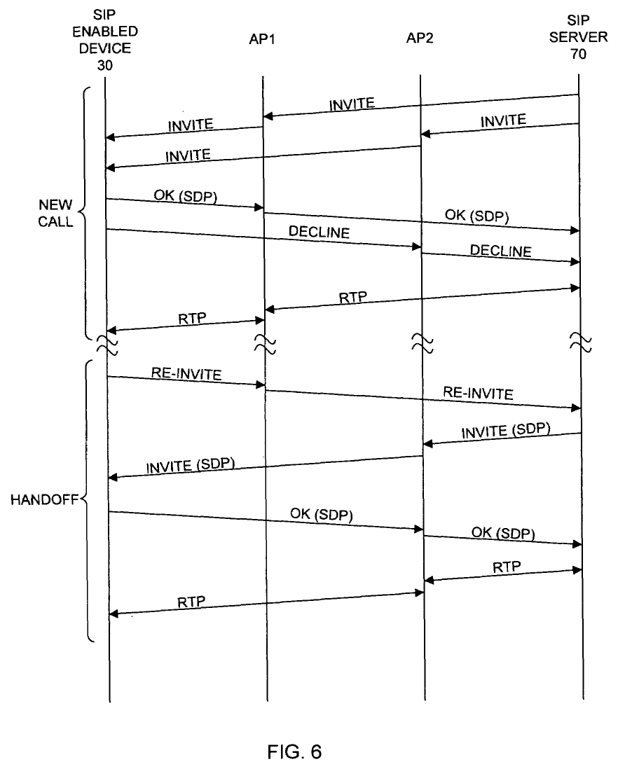

Thus, the device 30 as shown in FIG. 2 has registered connections with each of APs 36-38 and has been assigned a different IP address by each of the APs 36-38. The significance of the multiple IP address assignments is discussed below in connection with the handoff process (FIGS. 5 and 6). Wi-Fi site surveys can be conducted by the device 30 at specified intervals and the table 42 can be updated accordingly.

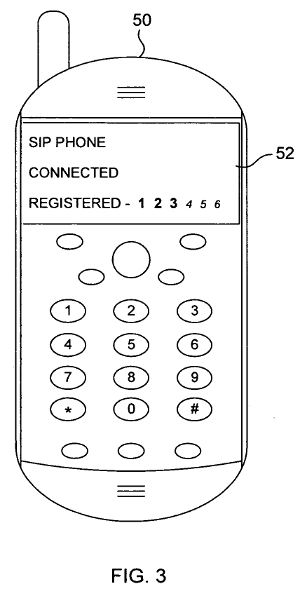

FIG. 3 shows a SIP phone 50 as an embodiment of a SIP enabled device according to the present invention. The phone 50 includes a display 52. The display 52 includes a visual indication of the number of available connections and the state of the available connections. In this embodiment, the phone 50 can support up to six concurrent connections. The view in FIG. 3 shows a condition where three of the connections (1-3) are registered and three of the connections (4-6) are free. The registered connections are visually distinct from the free connections in this embodiment by making the numbers associated with the registered connections bold and relatively large, whereas the numbers associated with the free connections are relatively small and italicized.

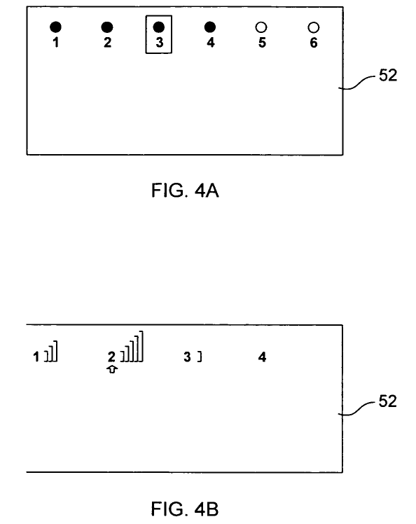

Alternative visual representations can be used without departing from the spirit and scope of the present invention. For example, FIGS. 4A and 4B show alternative visual representations of the status of phone connections. FIG. 4A shows an embodiment of the display 52 where there are six available connections. The registered connections are indicated by a solid circle (connections 1-4), whereas the free connections are indicated by an empty circle (connections 5-6). This example further provides an indication of the “active” registered connection by including a rectangle around the active connection (connection 3).

FIG. 4B shows an embodiment of the display 52 where there are four available connections. The registered connections are indicated by the presence of one or more bars (connections 1-3), whereas the free connection is indicated by the absence of any bars (connection 4). This example also provides an indication of the “active” registered connection by including an arrow pointing to the active connection (connection 2). This example further provides an indication of the strength of each of the registered connections. The strength of each registered connection is indicated by showing more bars for stronger connections and fewer bars for weaker connections. Thus, in the view shown in FIG. 4B, connection 2 is the strongest connection, while connection 3 is the weakest connection and the strength of connection 1 is between that of connections 2 and 3.

FIG. 5 shows a flowchart of an embodiment of a handoff process according to the present invention. For clarity, the process is described with reference to the device 30 shown in FIG. 2; however, such reference should not be construed as limiting. The process begins at 60 due to the initiation of a handoff. For example, the handoff can be initiated by the device 30 due to the automatic detection by the device 30 of a weak active signal, for example where the signal strength has fallen below a specified threshold. At 62, the device 30 checks the table 42 for the strongest available connection. Next, at 64, the device 30 issues a message for moving the connection to the new AP, which is preferably the AP with the strongest available connection as detected at 62. In some embodiments, the device 30 uses SIP messages for moving the connection. References herein to “SIP messages” can include messages described in Rosenberg et al., “SIP: Session Initiation Protocol (RFC 3261)” IETF (June 2002), which is hereby incorporated by reference. For example, the device 30 can issue a RE-SITE message that specifies the IP address assigned to the device 30 by the AP with the strongest available connection (i.e., the AP to which the device 30 wants to handoff the connection). At step 66, the device 30 commences use of the IP address for the AP with the strongest available connection, and the handoff process is complete. An embodiment of this handoff process is discussed in greater detail below with reference to FIG. 6.

FIG. 6 shows an example of how SIP: messages can be used for initiating a connection between a SIP enabled device 30 and a first access point AP1 (“NEW CALL”), and for performing a handoff from access point AP1 to access point AP2 (“HANDOFF”). The messages shown in FIG. 6 are not intended to be an exhaustive set of messages; additional messages such as “ACK,” “Trying,” and “Ringing,” are not shown. In the illustrated example, the device 30 is suitable for use as a SIP phone, so the connection is being initiated as a result of an incoming call. In the example illustrated in FIG. 6, the device 30 has registered connections with AP1 and AP2; the device 30 has been issued first and second IP addresses from AP1 and AP2, respectively. Initially, the signal from AP1 is stronger than the signal from AP2. The SIP server 70 allows the device 30 to be registered under multiple IP addresses. The SIP server 70 issues an INVITE message to each of the two IP addresses assigned to device 30. The first INVITE is addressed to the device 30 using the IP address assigned by AP1; thus, the first INVITE is routed through AP1. Similarly, the second INVITE is addressed to the device 30 using the IP address assigned by AP2; thus, the second INVITE is routed through AP2.

Upon receiving multiple INVITE messages, the device 30 will accepts the call from one of the APs and decline the call from the remaining APs. Here, the device 30 recognizes that the strongest signal is from AP 1, so the device responds to the INVITE from AP 1 with an OK message, which can include Session Description Protocol (SDP) information for the connection. The device 30 also responds to the INVITE from AP2 with a DECLINE message. The connection is thus established between the device 30 and AP1, so the data, such as audio Real-Time Transport Protocol (RTP) data in the case of a SIP call, can be exchanged. While FIG. 6 shows the RTP data being exchanged between the SIP server 70 and the APs, actual implementations of such a network can bypass the SIP server 70 with the RTP data.

At some point, the device 30 recognizes the need for a handoff. As shown at step 62 in FIG. 5, the device 30 checks for the AP with the strongest signal. In the example shown in FIG. 6, the signal from AP2 is stronger so the device 30 will handoff the connection from AP1 to AP2. As shown at step 64 (FIG. 5), the device 30 sends a RE-INVITE SIP message to AP1 for moving the connection. AP1, in turn, sends the RE-INVITE message to the SIP server 70. The RE-INVITE message includes instructions for the server 70 to send an INVITE message to the IP address assigned to the device 30 by AP2. In response, the server 70 sends an INVITE message to the device 30 via AP2. Note that, unlike the call initiation process where the server 70 sends an INVITE to all IP addresses assigned to the device 30, during the handoff the server 70 only sends an INVITE to the IP address assigned to the device 30 by AP2, which is the AP that the device 30 is trying to begin using for continuing the call (i.e., the IP address identified by the device 30 in the RE-INVITE message).

Upon receiving the INVITE message addressed to the IP address assigned to the device 30 by AP2, the device 30 replies with an OK message, which again can include SDP data. Upon receiving the OK message from device 30, the RTP data for the call is routed via AP2 to the device 30, completing the handoff process.

While various embodiments in accordance with the principles disclosed herein have been described above, it should be understood that they have been presented by way of example only, and are not limiting. Thus, the breadth and scope of the invention(s) should not be limited by any of the above-described exemplary embodiments, but should be defined only in accordance with the claims and their equivalents issuing from this disclosure. Furthermore, the above advantages and features are provided in described embodiments, but shall not limit the application of such issued claims to processes and structures accomplishing any or all of the above advantages.

Additionally, the section headings herein are provided for consistency with the suggestions under 37 CFR 1.77 or otherwise to provide organizational cues. These headings shall not limit or characterize the invention(s) set out in any claims that may issue from this disclosure. Specifically and by way of example, although the headings refer to a “Technical Field,” such claims should not be limited by the language chosen under this heading to describe the so-called technical field. Further, a description of a technology in the “Background” is not to be construed as an admission that technology is prior art to any invention(s) in this disclosure. Neither is the “Brief Summary” to be considered as a characterization of the invention(s) set forth in issued claims. Furthermore, any reference in this disclosure to “invention” in the singular should not be used to argue that there is only a single point of novelty in this disclosure. Multiple inventions may be set forth according to the limitations of the multiple claims issuing from this disclosure, and such claims accordingly define the invention(s), and their equivalents, that are protected thereby. In all instances, the scope of such claims shall be considered on their own merits in light of this disclosure, but should not be constrained by the headings set forth herein.

What is claimed is:

1. A session initiation protocol (SIP) device, comprising:
a SIP enabled application for securing a plurality of registered internet protocol (IP) connections to respective wireless access points; and
a network interface for issuing a SIP message for transferring a data stream from one of the registered IP connections to another, thereby changing which of the registered IP connections is an active connection.

2. The device of claim 1, wherein the SIP enabled device comprises a memory for storing information about the plurality of registered connections.

3. The device of claim 2, wherein the information in the memory includes a plurality of IP addresses assigned to the device by respective access points.

4. The device of claim 2, wherein the information in the memory includes information about a strength of the signals received from each of the access points.

5. The device of claim 1, wherein the SIP message includes an IP address assigned to the device by an access point associated with a strongest available connection.

6. The device of claim 5, wherein the SIP message includes a RE-INVITE message.

7. The device of claim 1, wherein the SIP device is a SIP phone.

8. The device of claim 1, further comprising a display showing a connection status of each of the plurality of registered IP connections.

9. A method of controlling a session initiation protocol (SIP) device, comprising:
securing a plurality of registered internet protocol (IP) connections to respective wireless access points; and
issuing a SIP message for transferring a data stream from one of the registered IP connections to another, thereby changing which of the registered IP connections is an active connection.

10. The method of claim 9, further comprising storing information about the plurality of registered connections.

11. The method of claim 10, wherein the storing of information includes storing a plurality of IP addresses assigned to the device by respective access points.

12. The method of claim 10, wherein the storing of information includes storing information about a strength of the messages received from each of the access points.

13. The method of claim 9, wherein the SIP message includes an IP address assigned to the device by an access point associated with a strongest available connection.

14. The method of claim 13, wherein the SIP message includes a RE-INVITE message.

15. The method of claim 9, wherein the SIP device is a SIP phone.

16. The method of claim 9, further comprising displaying a connection status of each of the plurality of registered IP connections.

17. A handoff method for a session initiation protocol (SIP) device for transferring an active connection from a first access point to a second access point, comprising:
selecting an access point to serve as the second access point from among a plurality of access points with which the device has a registered connection by determining which of the plurality of access points is providing a strongest signal;
sending a first SIP message via the first access point, wherein the SIP message includes an IP address assigned to the device by the selected second access point;
receiving a second SIP message via the selected second access point that was issued in response to the first SIP message; and
sending a third SIP message in response to the second SIP message indicating that data will be accepted from the selected second access point.

18. The method of claim 17, wherein the first SIP message is a RE-INVITE message.

19. The method of claim 17, wherein the second SIP message is an INVITE message.

20. The method of claim 17, wherein the third SIP message is an OK message.
